(19) United States
(12) Patent Application Publication
(10) Pub. No.: US 2009/0105421 A1
(43) Pub. Date: Apr. 23, 2009

(54) Joint Boot

(76) Inventors: Yoshiyuki Takeishi, Kanagawa (JP); Yoshifumi Kojima, Kanagawa (JP)

Correspondence Address: BUTZEL LONG;IP DOCKETING DEPT, 350 SOUTH MAIN STREET, SUITE 300, ANN ARBOR, MI, 48104, US

(21) Appl. No.: 11/921,482

(22) PCT Filed: May 9, 2006
(86) PCT No.: PCT/JP2006/309291

§ 371 Date: Dec. 3, 2007

(30) Foreign Application Priority Data
Jun. 2, 2005 (JP) 2005-162182

(51) Int. Cl. C08L 33/24

(52) U.S. Cl. 525/218; 277/634

(57) ABSTRACT

A joint boot molded from an acrylic rubber/polyamide-based thermoplastic elastomer, which comprises a polyamide resin and a cross-linked acrylic rubber. The acrylic rubber/polyamide-based thermoplastic elastomer is a dispersion of the rubber in the polyamide resin, obtained by dynamic cross-linking of the acrylic rubber, preferably by covalent bond-linkable cross-linking of the polyamide resin with the acrylic rubber. The joint boot has a fully satisfactory heat resistance required even for use at the inboard side.

### TECHNICAL FIELD

The present invention relates to a joint boot, and more particularly to a joint boot molded from a thermoplastic elastomer having a distinguished heat resistance.

### BACKGROUND ART

The drive shaft for automobiles is provided with universal joints each at the engine side and the wheel side, the joints being covered each by joint boots as joint cover to keep a grease within the joints.

In some cases, the joint boots are used at a high speed revolution state, or subjected to flexions, or in an extremely low temperature zone in a flexed state because of mounting on the drive shaft.

The joint boots can be classified into an outboard side (tire side) use and an inboard side (engine side) use, depending on use sites. To further improve the recycle rate of automobile parts as the recent trend, materials of parts for the outboard side use are now going to change from the vulcanized rubber materials to thermoplastic elastomer materials, specifically change from the chloroprene-based rubber to the recyclingable polyester-based thermoplastic elastomer having a high strength, a high flexibility and a distinguished moldability.

Patent Literature 1: JP-A-9-037802

Materials for the inboard side use, on the other hand, require no such a high flexibility as in the case of materials for the outboard side use, but require a higher heat resistance than that of the polyester-based thermoplastic elastomer, because of mounting at the engine-neighboring site. Thus, it has been heretofore considered difficult to change the joint boot materials for the inboard side use from the vulcanized rubber to the thermoplastic elastomer. That is, no inboard side joint boots made of thermoplastic elastomer have been produced yet.

Patent Literature 2: JP-A-2003-286341

Patent Literature 3: JP-A-1-306456

### DISCLOSURE OF THE INVENTION

### Problem to Be Solved By the Invention

An object of the present invention is to provide a joint boot molded from a thermoplastic elastomer, capable of fully satisfying the heat resistance required for the inboard side use.

### Means for Solving The Problem

The object of the present invention can be attained by a joint boot molded from an acrylic rubber/polyamide-based thermoplastic elastomer, which comprises a polyamide resin and a cross-linked acrylic rubber. The acrylic rubber/polyamide-based thermoplastic elastomer for use herein includes a dispersion of acrylic rubber in the polyamide resin by dynamic cross-linking of the acrylic rubber, preferably that by covalent bond-linkable cross-linking of the polyamide resin with the acrylic rubber.

### EFFECT OF THE INVENTION

The present joint boot has good low-temperature and high- temperature durabilities and grease resistance, and is particularly distinguished in a high-temperature durability at a high temperature such as 150° C., and a grease resistance, and thus is effectively suited to the inboard side (engine side) use particularly requiring the heat resistance. Furthermore, the oil resistance, molding processability, flexion resistance, crack growth resistance, compression set characteristics, weathering resistance, ozone resistance, etc. can be also satisfied, depending on the material characteristics of thermoplastic elastomers to be used.

### BEST MODES FOR CARRYING OUT THE INVENTION

Polyamide-based thermoplastic elastomer containing dispersed cross-linked acrylic rubber for use in the present invention preferably includes a dispersion of acrylic rubber in polyamide resin by dynamic cross-linking of acrylic rubber by a cross-linking agent, more preferably that by covalent bond-linkable cross-linking of polyamide resin with acrylic rubber.

Polyamide resin is used in a proportion of 20-60% by weight, preferably 20-55% by weight, on the basis of sum total of polyamide resin and acrylic rubber. When the polyamide resin is more than 60% by weight, the hardness will be increased, and the elastomeric properties will be lost, whereas in a proportion of less than 20% by weight, the thermoplastic properties will be lost.

The polyamide resin for use herein includes nylon resins having a softening point or a melting point of 160° C.-280° C., such as nylon 3, nylon 4, nylon 6, nylon 7, nylon 8, nylon 42, nylon 46, nylon 66, nylon 69, nylon 610, nylon 11, nylon 12, nylon 666 (copolymer of caprolactam and hexamethylene adipamide), etc. alone, in mixtures or as copolymers thereof.

Acrylic rubber for use in the covalent bond-linkable cross-linking preferably includes α-olefin-alkyl (meth)acrylate copolymer having a distinguished heat resistance, because the covalent bond-linkable cross-linking with polyamide resin is carried out by dynamic cross-linking under heated conditions at about 100° to about 350° C., preferably about 150° to about 300° C., more preferably about 180° to about 280° C., as disclosed in the afore-mentioned Patent Literatures 2 and 3. From the viewpoint of oil resistance, homopolymers or copolymers of alkyl (meth)acrylate or alkoxyalkyl(meth) acrylate, or copolymers thereof with α-olefin, or further polymer blends of these polymers, etc. can be used, when desired.

a -olefin for use herein includes a -olefins of C₂-C₁₂, preferably a -olefins of C₂-C₄, such as ethylene, propylene, butene-1, isobutylene, pentene, heptene, octene, decene, dodecene, etc. Alkyl (meth)acrylate for use herein includes acrylates having an alkyl group of C₁-C₁₂, preferably an alkyl group of C₁-C₄, such as methyl acrylate, ethyl acrylate, n-butyl acrylate, t-butyl acrylate, 2-ethylhexyl acrylate, octyl acrylate, decyl acrylate, dodecyl acrylate, etc., and methacrylates having an alkyl group of C₁-C₁₂, preferably an alkyl group of C₁-C₄, such as methyl methacrylate, ethyl methacrylate, n-butyl methacrylate, t-butyl methacrylate, 2-ethylhexyl methacrylate, octyl methacrylate, decyl methacrylate, dodecyl methacrylate, etc. Alkoxyalkyl (meth)acrylate for use herein includes alkoxyalkyl (meth)acrylates having an alkoxyl group of C₁-C₂, and an alkyl group of C₂-C₄, such as methoxyethyl acrylate, ethoxyethyl acrylate, methoxybutyl acrylate, ethoxybutyl acrylate, methoxyethyl methacrylate, ethoxyethyl methacrylate, methoxybutyl methacrylate, ethoxybutyl methacrylate, etc.

The copolymers are preferably further copolymerized with a (meth)acrylate containing a cross-linkable group such as a carboxyl group, a hydroxyl group, a chloride group, an epoxy group, a diene group, an isocyanate group, an amine group, an amide group, an oxazoline group, etc. generally, such (meth)acrylates containing a cross-linkable group as used in the acrylic rubber comprising alkyl (meth)acrylate (and alkoxyalkyl (meth) acrylate) as the main component can be used as such.

In the case of a -olefin-alkyl (meth)acrylate copolymers further copolymerized with the (meth)acrylate containing a cross-linkable group, copolymers having a composition comprising 10-69.9% by mole of α-olefin, 29.6-89.5% by mole of alkyl (meth)acrylate, and 0.5-10% by mole of (meth)acrylate containing a cross-linkable group can be used. Such copolymers are essentially non-crystalline, and have a glass transition temperature Tg of not higher than room temperature. Examples of such acrylic rubber copolymers are also disclosed in the following Non-Patent Literature 1. Alkoxyalkyl (meth)acrylate copolymers comprising 0.5-10% by mole of (meth)acrylate containing a cross-linkable group, the balance being any copolymer composition of alkyl (meth)acrylate and alkoxyalkyl (meth)acrylate, can be used. Furthermore, ethylene-monoalkyl ester of maleic acid copolymer, etc. can be also used.

Non-Patent Literature 1 : Rubber World Blue Book, pp393-4(1987)

Covalent bond-linkable cross-linking of polyamide resin with acrylic rubber copolymer can be carried out in the presence of a cross-linking agent selected in view of the kind of cross-linkable group in the acrylic rubber copolymer, for example, polyol, polyamine, polyisocyanate, epoxy group-containing compounds, etc. by a dynamic cross-linking process comprising melt-mixing the polyamide resin with the acrylic rubber copolymer at the afore-mentioned temperature, usually by a process of adding the cross-linking agent while kneading the polyamide resin with the acrylic rubber copolymer through a biaxial kneader. Other cross-linking process than the dynamic vulcanization process includes, for example, a process of fully vulcanizing the acrylic rubber in the absence of the polyamide resin by either dynamic method or static method, followed by pulverization, and mixing the polyamide resin at the melting point, or the softening point of the polyamide resin, etc.

The resulting acrylic rubber/polyamide-based thermoplastic elastomer, for example, a press film thereof (thickness:about 0.2 mm) has such a cross-linking density that 50% or more, preferably 30% or more, thereof is not extractable, when dipped in an organic solvent such as dichloromethane, toluene, tetrahydrofuran, etc. for 48 hours. The acrylic rubber/polyamide-based thermoplastic elastomer can be admixed with an ordinary plasticizer or filler such as phthalic acid ester, phosphoric acid ester, or carbon black, silica etc.

The acrylic rubber/polyamide-based thermoplastic elastomer can be produced by the afore-mentioned process. In the same system, those types, in which only the covalent bond-linkable cross-linking of the acrylic rubber with the polyamide is not conducted, include commercially available products, such as ZEON CHEMICALS products of Zeotherm series, which can be used as such.

The present composition can be further admixed with various additives, such as an antioxidant, a stabilizer, a tackifying agent, a mold release agent, a pigment, a flame retardant, etc. To further improve the strength and rigidity, finely particulate reinforcing components, short fibers, etc. can be added thereto.

The composition can be prepared by the well known mixing method, for example, by mixing through a biaxial extruder, a blender, a Henschel mixer, a monoaxial extruder, rolls, a Banbury mixer, a kneader, etc. Joint boots can be molded by blow molding, injection molding, compression molding, extrusion molding, etc. Now blow molding is preferable because physical properties of materials are substantially free of the anisotropy, and the molding can be conducted appropriately on materials in a plasticized state by heating at 230° -280° C. for 1-10 minutes.

### EXAMPLES

The present invention will be described in detail below, referring to Examples.

### Example 1

Acrylic rubber/polyamide-based thermoplastic elastomer (Zeotherm 100-90B pellets of Zeon Chemicals product) was dried at 100° C. for 5 hours, and plasticized by heating at 260° C. for 3 minutes through an injection molding machine to prepare test pieces (100 mm×100 mm×2 mm), and also plasticized by heating at 260° C. for 3 minutes through a blow molding machine to mold joint boots. The pellet materials, test pieces and molding products were subjected to functional and material evaluation as to melting point, hardness, low-temperature durability, grease resistance, and high- temperature durability.

Melting point: according to JIS K7121

Sampled pellet materials were tested by DSC, made by Seiko Instrument Co.

Hardness (type D): according to JIS K6253

Materials showing 55 or more by a type D durometer is not preferable for joint boot materials

Low-temperature durability: according to JIS K6261

Materials showing a brittleness temperature of less than −b 50° C. (<50° C.) are suited to boots, whereas those showing a brittleness temperature of −50° C. or higher are not satisfactory in the performance, when used as boots

Grease resistance: Test pieces are dipped in grease to determine a coefficient of cubic expansion after dipping at 150° C. for 70 hours

Materials showing a coefficient of cubic expansion of 10% or more are not preferable for the joint boot materials

High-temperature durability: Boot containing a predetermined amount of grease as sealed therein is mounted on a uniform speed joint, set to a revolution durability tester for the uniform speed joint boot and after setting the joint angle to 0°, number of revolutions is gradually increased up to 3,000rpm in the atmosphere at 150° C. to visually observe the boot shape

Boots undergoes revolutional expansion by the centrifugal force following the revolutions, and when the revolution rate is over a given rpm, the boot undergoes abnormal deformation and once such an abnormal deformation takes place, the boot may be brought into contact with other automobile parts during actual use, causing a serious trouble leading to an instantaneous rupture, and thus the revolution number causing an abnormal deformation is to determine as an index for the high-temperature durability

No occurrence of abnormal deformation at 3,000 rpm indicates a distinguished boot-shape retainability at high temperatures, that is, distinguished properties for the boot materials

### Examples 2 and 3

In Example 1, an acrylic rubber/polyamide-based thermoplastic elastomer, prepared by dynamic cross-linking of 6-nylon of extrusion molding grade with acrylic rubber of cold resistance grade comprising n-butyl acrylate and 2-methoxyethyl acrylate as the main components through a biaxial extruder to conduct covalent bond-linkable cross-linking, was used. Example 2 was different from Example 3 only in mixing proportion of 6-nylon to acrylic rubber (weight ratio 35-45:65-55%), and Example 3 had a higher proportion of acrylic rubber.

### Comparative Example 1

In Example 1, polyester-based thermoplastic elastomer (Arnytel PB-582-H, a DMS product) was used in place of the acrylic rubber/polyamide-based thermoplastic elastomer.

### Comparative Example 2

In Example 1, polyamide-based thermoplastic elastomer (Glyron EL-X50HNZ, an Ames-Showa Denko product) was used in place of the acrylic rubber/polyamide-based thermoplastic elastomer.

### Comparative Example 3

In Example 1, polyester-based thermoplastic elastomer (Hytrel 4767B, a Toray-DuPont product) was used in place of the acrylic rubber/polyamide-based thermoplastic elastomer.

Results of the foregoing Examples and Comparative Examples are shown in the following Table. It can be apparent from the results shown in the Table that:

(1) Joint boots obtained in all of Examples had good low-temperature and high-temperature durabilities and grease resistance,

(2) Joint boot of Comparative Example 1 had a satisfactory high-temperature durability due to the high hardness, but a poor grease resistance, and thus was not satisfactory in the balance, and

(3) In joint boots of Comparative Examples 2 and 3, abnormal deformation was observed in the high-temperature durability test.

TABLE

| Functional/ | | | | | | |
|---|---|---|---|---|---|---|
| material | Example No. | | | Comp. Ex. No. | | |
| evaluation | 1 | 2 | 3 | 1 | 2 | 3 |
| Melting point | 220 | 222 | 219 | 220 | 210 | 206 |
| (° C.) | | | | | | |
| Hardness | 42 | 51 | 45 | 55 | 44 | 47 |
| (type D | | | | | | |
| durometer) | | | | | | |
| Low-temp. | <−50 | <−50 | <−50 | <−50 | <−50 | <−50 |
| durability | | | | | | |
| (° C.) | | | | | | |
| Grease | +3.3 | +2.6 | +3.1 | +15.7 | +15.6 | +14.5 |
| resistance | | | | | | |
| (ΔV %) | | | | | | |
| High-temp. | >3000 | >3000 | >3000 | >3000 | 2600 | 2700 |
| durability | | | | | | |
| (rpm) | | | | | | |

1. A joint boot, molded from an acrylic rubber/polyamide-based thermoplastic elastomer, which comprises a polyamide resin and a cross-linked acrylic rubber, for use at an the inboard side of a drive shaft. (engine side).

2. A joint boot according to claim 1, wherein the acrylic rubber/polyamide-based thermoplastic elastomer contains 20-60% by weight of polyamide resin on the basis of sum total of the polyamide resin and the cross-linked acrylic rubber.

3. A boot joint according to claim 1, wherein the acrylic rubber/polyamide-based thermoplastic elastomer is a dispersion of the rubber in the polyamide resin, obtained by dynamic cross-linking of the acrylic rubber.

4. A boot joint according to claim 3, wherein the acrylic rubber is a copolymer of a-olefin, alkyl (meth)acrylate and a cross-linkable group-containing (meth)acrylate.

5. A boot joint according to claim 1, wherein the acrylic rubber/polyamide-based thermoplastic elastomer is a covalent bond-linkable cross-linking produce of polyamide resin with acrylic rubber.

6. A boot joint according to claim 5, wherein the acrylic rubber is a copolymer of a-olefin (meth)acrylate and a cross-linkable group-containing (meth)acrylate.

7. A boot joint according to claim 6, wherein the covalent bond-cross-linkable cross-linking is carried out by dynamic cross-linking at about 100° to about 350° C. Claim 8. (canceled)
